(19) United States
(12) Patent Application Publication
(10) Pub. No.: US 2024/0036584 A1
(43) Pub. Date: Feb. 1, 2024

(54) TIME-FREQUENCY PLANNING FOR RADARS ON VEHICLES IN A WAREHOUSE ENVIRONMENT

(71) Applicant: UHNDER, INC., Austin, TX (US)

(72) Inventors: Wayne E. Stark, Ann Arbor, MI (US); Ali Erdem Ertan, Austin, TX (US); Murtaza Ali, Cedar Park, TX (US)

(21) Appl. No.: 18/359,133

(22) Filed: Jul. 26, 2023

Related U.S. Application Data
(60) Provisional application No. 63/369,566, filed on Jul. 27, 2022.

(51) Int. Cl. G05D 1/02; G01S 13/76; G01S 13/88

(52) U.S. Cl. CPC G05D 1/0257; G01S 13/76; G01S 13/881; G05D 2201/0216

(57) ABSTRACT

A radar system includes a transmitter pipeline, a receiver pipeline, and a controller. The transmitter pipeline includes transmitters, each transmitting radio signals. The receiver pipeline includes receivers, each receiving radio signals that include signals transmitted by the transmitters and reflected from objects in an environment. The controller is configured to control the operation of the transmitter pipeline and the receiver pipeline as defined by a coordination signal received from a local controller. At least one of the transmitter pipeline and the receiver pipeline avoid interference from other radar systems as defined by the controller.

### CROSS REFERENCE TO RELATED APPLICATION

The present application claims the filing benefits of U.S. provisional application, Ser. No. 63/369,566, filed Jul. 27, 2022, which is hereby incorporated by reference herein in its entirety.

### FIELD OF THE INVENTION

The present invention is directed to radar systems, and in particular to multiple-input, multiple-output (MIMO) radar systems for vehicles and robotics.

### BACKGROUND OF THE INVENTION

The use of radar to determine range, velocity, and angle (elevation or azimuth) of objects in an environment is important in a number of applications including automotive radar and gesture detection. Radar systems typically transmit a radio frequency (RF) signal and listen for the reflection of the radio signal from objects in the environment. A radar system estimates the location of objects, also called targets, in the environment by correlating delayed versions of the received radio signal with the transmitted radio signal. A radar system can also estimate the velocity of the target by Doppler processing. A radar system with multiple transmitters and multiple receivers can also determine the angular position of a target. Depending on antenna scanning and/or the number of antenna/receiver channels and their geometry, different angles (e.g., azimuth or elevation) can be determined.

Mobile vehicles or mobile robots are used for various purposes in a warehouse, such as moving containers from one location to another location. For example, a warehouse might move products from one storage location to a location for shipping. The mobile robots need to sense the environment they operate in so as to not crash into other robots or other items on the warehouse floor. One way to sense the environment is by the use of radars. The robots may need high-resolution so as to enable the ability to plan a path. These requirements may dictate the use of high bandwidth radars and multiple transmit and receive antennas resulting in a large amount of power transmitted. However, radars on different robots will interfere with each other. The signal from the transmission of a radar received at the radar because of the reflection off an object will decay much faster with distance than the signal received directly from an interfering radar. In a warehouse utilizing a large number of mobile robots the interference from other radars can be substantial. Radars very far apart from each other will not cause significant interference but radars nearby will. There is a need for a medium access control (MAC) protocol that can allow radars to transmit without causing significant interference to other radars nearby.

### SUMMARY OF THE INVENTION

Exemplary embodiments provide methods and a system for a radar system that operates within an operational environment with a plurality of other radar systems. The present invention provides for a large number mobile vehicles operating in a warehouse or like building sensing objects in the environment. A mobile vehicle has one or more radar systems. Each radar system has one or more radar transmitters and one or more radar receivers. In addition, there is a control processor as part of the mobile vehicle that determines the frequency subband used by the one or more radars and the transmit times of the one or more radars with the goal of operating at the time and frequency to minimize interference.

The mobile vehicle also has an interference measuring subsystem that can determine the interference of other signals from other radar systems operating on other mobile vehicles and adjust the frequency of operation and the time of operation of the its radars.

The present invention also includes a central controller separate from the mobile vehicles. The central controller communicates with the mobile vehicles to control the transmission times and frequency bands used by radars on different mobile vehicles. The mobile vehicles can communicate information back to the central controller informing the central controller the interference levels. Alternatively, the central controller can determine the frequency subband and time of transmissions by knowing the geographical location within the warehouse of each mobile vehicle.

A radar system in accordance with an embodiment of the present invention includes a transmitter pipeline, a receiver pipeline, and a controller. The transmitter pipeline includes transmitters, each transmitting radio signals. The receiver pipeline includes receivers, each receiving radio signals that include signals transmitted by the transmitters and reflected from objects in an environment. The controller is configured to control the operation of the transmitter pipeline and the receiver pipeline as defined by a coordination signal received from a local controller. At least one of the transmitter pipeline and the receiver pipeline avoid interference from other radar systems as defined by the controller.

In an aspect of the present invention, the radar system transmits a signal, for example, that is either a frequency modulated continuous wave signal or a phase modulated continuous wave signal.

### BRIEF DESCRIPTION OF THE DRAWINGS

FIG. 1 shows a warehouse with a number of robots, each with one or more radars;

FIG. 2 shows a robot with a number of radars;

FIG. 3 shows a radar with a number of transmit antennas, receive antennas and a processor;

FIG. 4 shows the time-frequency resources available for use by a radar;

FIG. 5 shows a warehouse with mobile robots and a central controller;

FIG. 6 shows a method for choosing a resource to use for transmission;

FIG. 7 shows a method for monitoring the interference level;

FIG. 8 shows the time-frequency of the radar transmission and interference measuring;

FIG. 9 shows one interference measuring system; and

FIG. 10 shows the timing of the transmission and reception during a single slot.

These and other objects, advantages, purposes and features of the present invention will become apparent upon review of the following specification in conjunction with the drawings.

### DESCRIPTION OF THE PREFERRED EMBODIMENTS

Referring to the drawings and the illustrative embodiments depicted therein, wherein numbered elements in the following written description correspond to like-numbered elements in the figures, an exemplary radar system operates within an operational environment with a plurality of other radar systems. Whether through the use of a coordinated planning method or an uncoordinated planning method, the exemplary embodiments provide for a plurality of radars occupying the same geographical area to select or be directed to different frequencies and at selected or directed time slots to avoid or at least mitigate interference among the plurality of radar system.

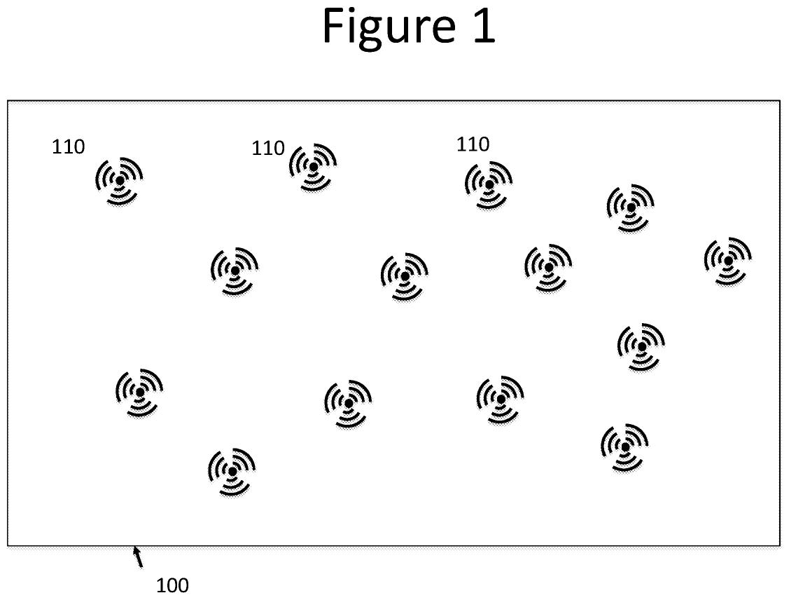

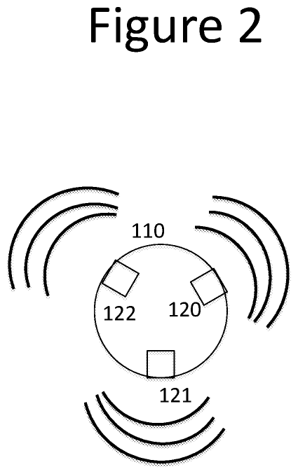

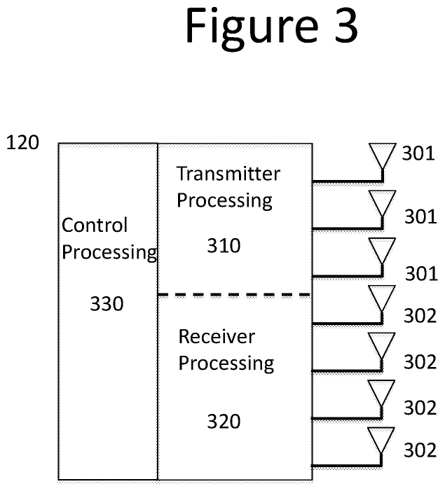

Consider a warehouse of a certain area with a large number of robots/vehicles. FIG. 1 shows a warehouse (100) with a number of robots (110). There could be hundreds of such robots/vehicles. The robots have radar sensors. Each robot could have multiple radar sensors. FIG. 2 shows a robot (110) with three radar sensors (120, 121, 122). There can be any number of radars on the robot with any field of view for each radar. In one embodiment each radar has three radars that each have 120-degree field of view, so that overall, the robot has a full 360-degree field of view. There can be N radars on each robot with each radar having a 360/N field of view for full exposure of the environment. Alternatively, each radar could have a larger or smaller field of view than the 360/N field of view. FIG. 3 shows a single radar (120) with multiple transmit antennas (301), receive antennas (302), transmitter section (310), and a receiver section (320). There can be shared components between transmitter and receiver. In addition, there is a processing section (330) that controls the transmitter and receiver. All of these sections of the radar unit could be implemented on a single chip or there could be multiple chips to implement the radar. Each radar could consist of multiple transmitter antennas and multiple receive antennas in order to be able to determine the location of a target object to be detected. A control processor could control multiple radars on a single robot. The receiver processing subsystem (320) can be employed to also measure the interference from other radars while not actively being used to measure reflections of the signals from the transmitter.

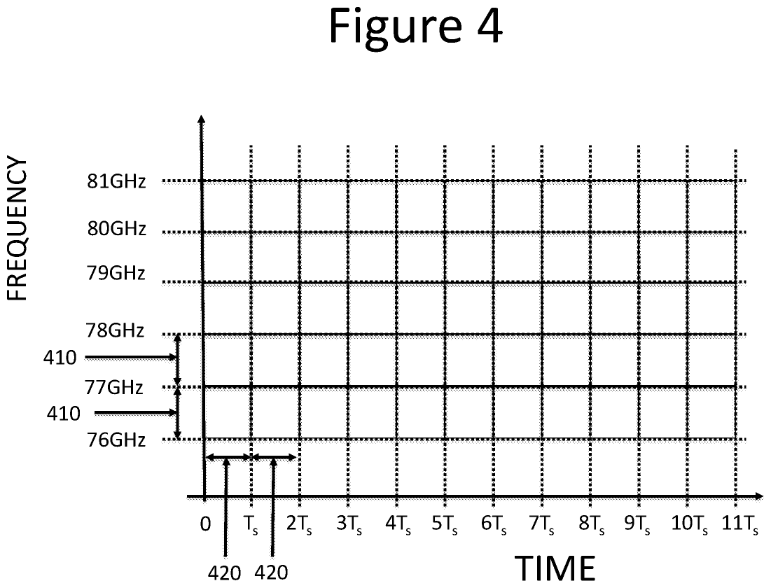

There is some available bandwidth that radars can employ. FIG. 4. Illustrates the time-frequency resources that are available. As an example, the frequency band from 76-81 GHz is available for radar services providing 5 GHz of operating bandwidth. This frequency band can be divided into different subbands (410). In the preferred embodiment the 5 GHz spectrum is divided into 5 bands of 1 GHz each. A larger bandwidth in each subband for each radar provides better range resolution but results in a smaller number of subbands that can be allocated to different robots. Robot radars need not continuously transmit. Each robot could transmit for a short duration, e.g. Ts=10 ms, and then listen for some period of time, e.g. 90 ms, before transmitting again. In FIG. 4, the time slots for transmitting are shown (420). In this embodiment a robot could use 10 different starting times for the radars to transmit a signal. In this way not all robots are transmitting on the same frequency band at the same time. There are a number of frequency-time resources available that can a robot can use in order to sense the environment. FIG. 4 illustrates the time-frequency resources that are available. Note that the time-frequency resources need not be completely disjoint. It is possible that the frequency band can be divided into multiple overlapping subbands and similarly for the time resources. It is also possible that the frequencies used are not contiguous.

The mobile vehicle warehouse system by design would need to adapt to a changing environment because other vehicles are moving or objects (e.g., people) are moving. Assuming that the conditions change at a slow rate compared to the time duration for a system to scan the performance can determined assuming a static condition. The performance can be measured in several ways. One performance measure is the outage probability. This is the probability that the signal-to-interference plus noise (SINR) is below a threshold. Alternatively, the outage probability could be just the probability that the interference is above a certain level. This later definition is independent of the target object radar cross section and the distance of the object. The interference from a radar distance di will be proportional to 1/di2, while the signal reflected off an object at distance do will be proportional to 1/do4.

There are two possible approaches for MAC protocols to mitigate the interference from other radars. In one approach there is a central controller that can communicate with each individual robot and instruct the robot when to transmit a signal and in what frequency band. In another approach each radar would decide when to transmit and in which frequency band. The first method is called a coordinated MAC protocol, while the latter is called an uncoordinated MAC protocol. In order to decide whether or not to use a particular time-frequency resource, a robot would need to sense the interference present in a particular time-frequency resource. As such the robot would use the radar to transmit for a certain period of time but would listen to the interference at other times. It is also possible that the robot could simultaneously measure the interference and transmit at the same time in the same or a different frequency subband.

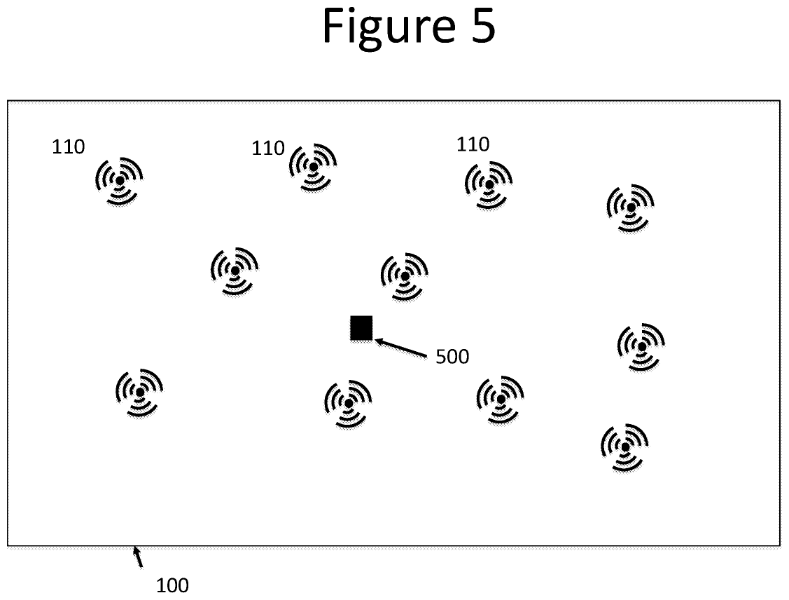

FIG. 5 illustrates the approach with a central coordinator (500). In the coordinated approach of operation there is a central controller (500) that communicates with each mobile robot (110) and instructs the mobile robot which time/frequency resource to use. The central controller (500) knows the position in the warehouse of each robot (110) and based on the position allocates time/frequency resources so as to minimize interference, for example. The mobile robots could report interference levels to the central controller in order that the central controller could allocate the resources to minimize the interference at different radars. Depending on the size of the warehouse there could be multiple transmitters geographically distributed that the central controller uses to transmit control information to each robot. The central controller could also send out short pulses in the same frequency band as the robots in order to synchronize the time reference of different robots. There are different methods that can be employed to synchronize different users.

There are several methods a central controller could use to allocate time/frequency resources. One method of allocating time/frequency resources to users is based on the position of the robots without knowing the actual interference level at each robot/radar. The warehouse could be divided into small regions where in each region a unique time/frequency resource is allocated and that same resource is only used in another region sufficiently far away as to minimize the interference level. Alternately if the central controller knows the interference level experienced at each radar in each resource, the central controller can use that information to allocate time/frequency resources to achieve a certain objective. The objective could be the probability of an outage where an outage is the event that the interference level is above a threshold.

Another method a central controller could use to allocate time/frequency resources is based on the interference level experienced at each radar. For example, for one robot, if the interference level is above a threshold, then the central controller could instruct the robot to change to a new resource where the new resource is the resource with the smallest interference level. This could be done one-by-one for each robot sequentially. Assuming that the interference level is constant during this process once all robots have been possibly reallocated resources the process can repeat. This process is adaptive in that as robots move about in the warehouse the interference level will change and thus the allocation of time/frequency resources will also change.

The central controller could also adjust the number of subbands used, the time duration of a transmission of a radar signal and the periodicity of transmissions. For example, if the number of robots was so large that the allocation of resources resulted in a large outage probability then the central controller could change the periodicity of the radar transmissions in order to accommodate more resources at the expense of a longer time between updates of the environmental sensing. Alternatively, the central controller could allocate the bandwidth into smaller subbands thus creating more subbands in order to accommodate more robots without creating more interference. Note that the more subbands with smaller bandwidth each, the worse the range resolution would be. Similarly, the larger the time period between transmissions, the smaller the accuracy of the robot sensing the environment since the assumption is that many of the robots may be mobile and thus the environment is changing with time.

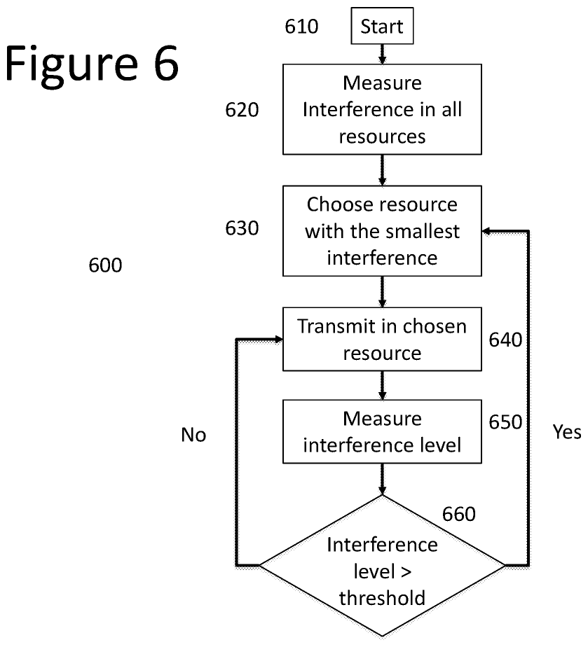

A second approach is a decentralized scheme in which each robot operates without the use of a central controller. In a decentralized scheme each robot decides which frequency subband to use and at which times to transmit. A radar could measure the interference level in each of the different resources and based on that decide which resource would result in the smallest interference. FIG. 6 shows a method (600) for a robot to decide which resource to use to transmit a radar sensing signal. The method (600) starts (610) and first measure the interference in all resources (620). The radar then chooses the resource with the smallest interference level (630). The radar transmits using that resource (640). The radar measures the interference level in other resources (650). If the interference level in the chosen resource is larger than some threshold (660), the radar will change which resource is being used (630) to transmit (640). On the other hand, if the interference level in the chosen resource is smaller than a certain threshold (660), then the radar will continue to use the same resource. The decision about whether or not to change resource could be based other measures such as the signal-to-noise ratio from a target object at a certain location rather than the interference level.

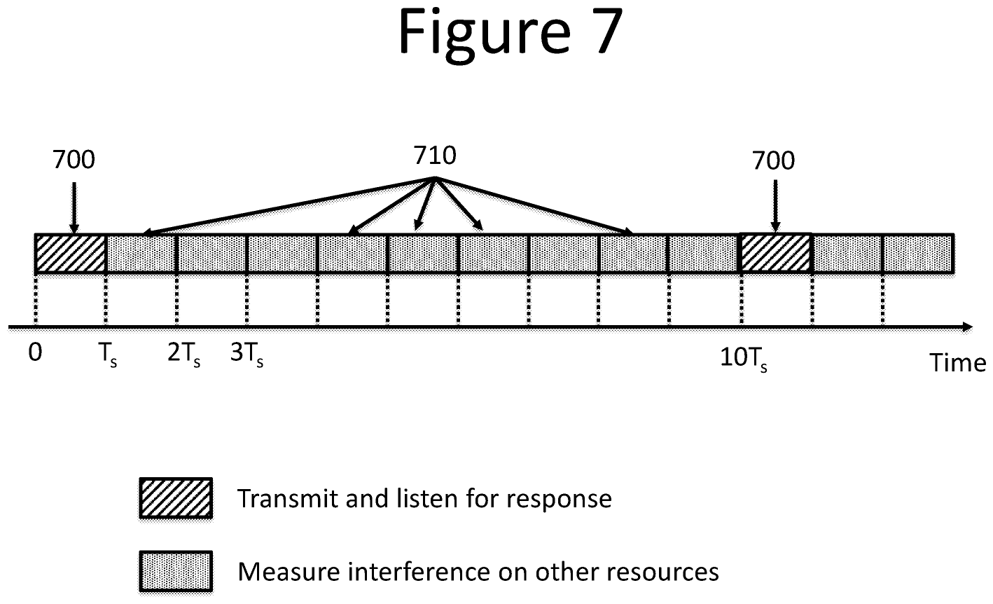

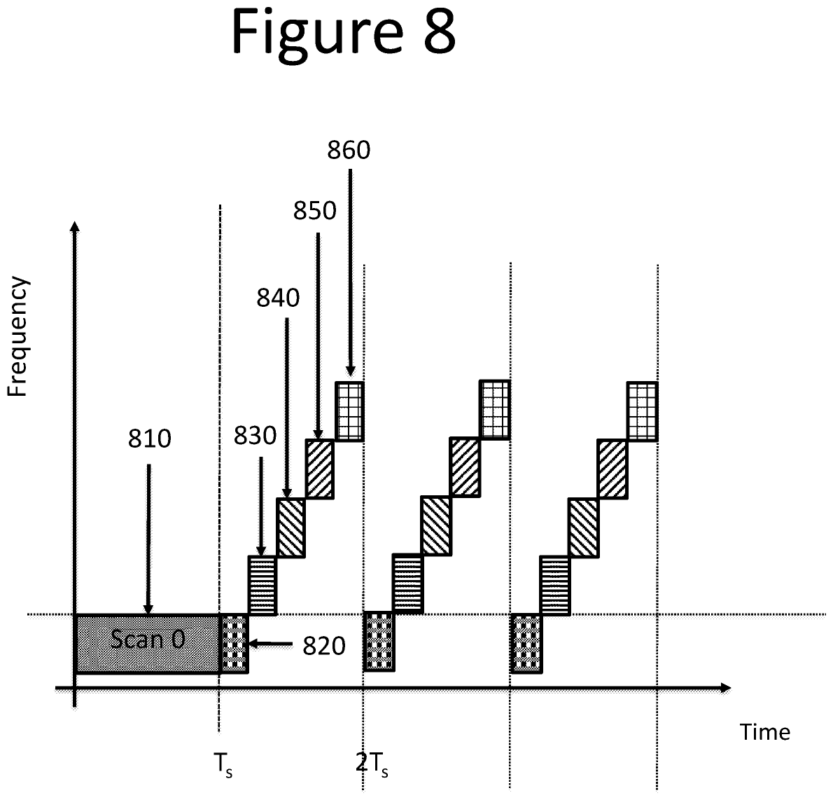

The radar system can transmit a scan during a certain time interval and then measures the interference in other time slots. FIG. 7 illustrates this concept. During the time interval [0, Ts] a radar transmits (700) a signal and listens for a response using some resource (time/frequency). The time interval here is just based on the robot's own clock, not an absolute time. Following the transmission and listening for responses, the radar tunes to other frequencies and measures the interference level in time slots 710. FIG. 8 shows more details of this process. During the time interval [0, Ts] a robot transmits and listens for the response due to the radar transmission in order to sense the environment. Then the robot listens at the same frequency to determine the level of interference at that frequency (820). The robot then listens (830) at a different frequency for a similar period of time (e.g., Ts/5). During the next time interval (840) the user measures the response at a different frequency resource (subband). During the next time interval, the robot measures the interference in a different subband (850). This continues until all subbands have been measured. The duration for measuring the interference, in this embodiment, in each of the 5 subbands is the same as the duration of a scan. After the interference in all subbands have been measured then the system repeats the measurements corresponding to a different time resource. This continues for another 8 time slots. After 10 time slots the robot transmits a scan again to sense the environment as shown in FIG. 7 (700).

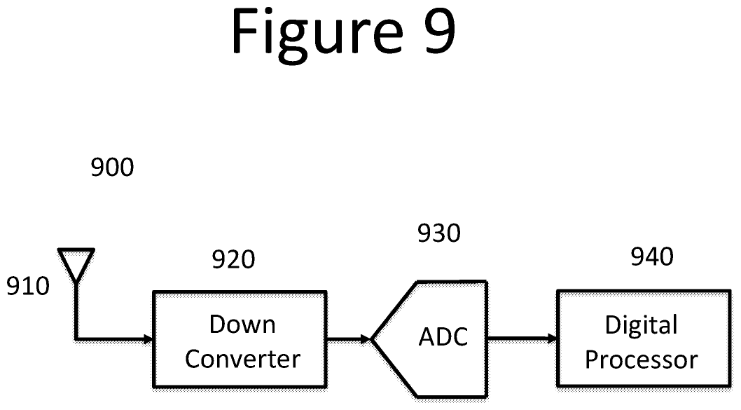

FIG. 9 illustrates the receiver interference measuring system. One or more antennas (910) can be used followed by a down converter (920) to down converter the signal to either baseband or an intermediate frequency. The result is sampled and converted to a digital sampled signal using an ADC (930). The sampled signal is processed by a digital processor (940) to estimate the interference level. The sampled signal could be a complex (real part and imaginary part) signal often called the inphase (I) and quadrature phase (Q) signals. The digital processor could comprise an infinite impulse response (IIR) filter that does a running average of the magnitude of the complex samples. Alternatively the filter could approximate the magnitude of the (I,Q) sample pair by max(I,Q)+min(I,Q)/4 in order to reduce the computation time. Note that in digital processing a divide by 4 is just a right shift of the digital representation by two positions. There can be multiple receive antennas that measure the interference along with multiple down converters, analog-to-digital converters, and digital processors although the digital processors could be integrated into one chip.

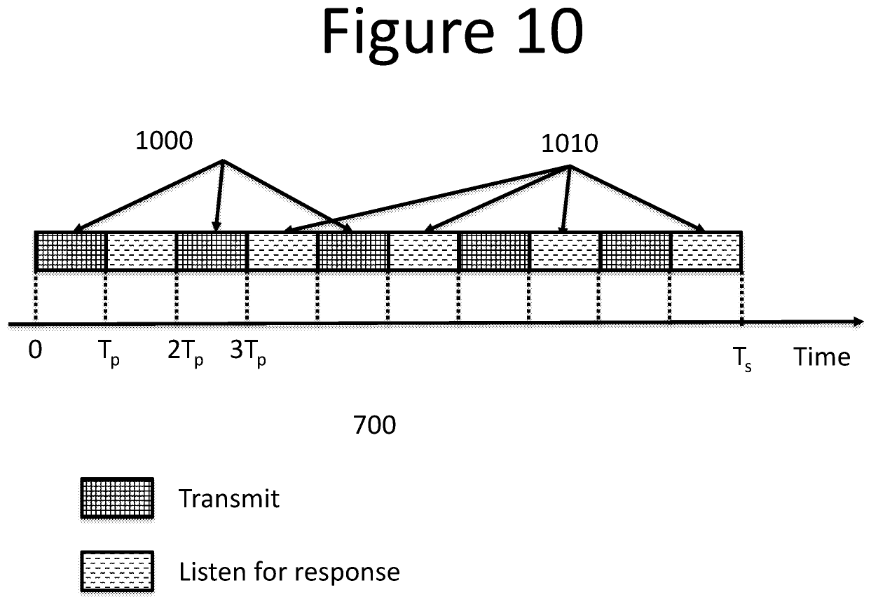

In one embodiment, during a slot, the radar periodical transmits a signal and listens for a response. FIG. 10 shows the timing of the transmissions in a single slot (700) for a single radar in this embodiment. The radar transmits a short transmission (1000) during the time interval [0, Tp] and then listens for a response (1010). This process repeats a number of times during a time slot of duration Ts. In another embodiment the radar system simultaneously transmits and listens for a whole slot. The type of signals a radar can transmit include a frequency modulated continuous wave (FMCW) signal or a phase modulated continuous wave (PMCW) signal. Thus, the exemplary embodiments discussed herein provide a radar system that operates within an operational environment with a plurality of other radar systems. Whether through the use of a coordinated planning method or an uncoordinated planning method, the exemplary embodiments provide for the plurality of radars occupying the same geographical area to select or be directed to different frequencies and at selected or directed time slots to avoid or at least mitigate interference among the plurality of radar systems.

Changes and modifications in the specifically described embodiments can be carried out without departing from the principles of the present invention which is intended to be limited only by the scope of the appended claims, as interpreted according to the principles of patent law including the doctrine of equivalents.

1. A radar system comprising:
a transmitter pipeline comprising a plurality of transmitters, each configured to transmit radio signals;
a receiver pipeline comprising plurality of receivers, each configured to receive radio signals that include signals transmitted by the plurality of transmitters and reflected from objects in an environment; and
a controller configured to control the operation of the transmitter pipeline and the receiver pipeline, as defined by a coordination signal received from a local controller;
wherein at least one of the transmitter pipeline and the receiver pipeline avoid interference from other radar systems as defined by the controller.

2. The radar system of claim 1, wherein the receiver pipeline and the transmitter pipeline operate at a frequency selected by the controller, as defined by the local controller.

3. The radar system of claim 1, wherein the receiver pipeline and the transmitter pipeline operate at a time slot selected by the controller, as defined by the local controller.

4. The radar system of claim 2, wherein the local controller is configured to select a frequency for the receiver pipeline and the transmitter pipeline from a plurality of frequencies.

5. The radar system of claim 1, wherein the controller is configured to select a frequency and time slot that avoids interference from other radar systems as defined by a ping signal transmitted by the local controller.

6. A mobile vehicle comprising:
one or more radar systems, wherein each radar system comprises:
one or more radar transmitters,
one or more radar receivers, and
a control processor wherein the control processor determines the frequency subband used by the one or more radars and the transmit times of the one or more radars.

7. The mobile vehicle of claim 6 wherein the mobile vehicle has an interference measuring subsystem that measures the interference level in different frequency bands at different times.

8. The system of claim 6 wherein the radars transmit with different power levels at different times.

9. The system of claim 6 wherein not all the radars on a mobile vehicle transmit at the same time.

10. The system of claim 6 wherein a during a transmission time the radar transmits a plurality of short pulses followed by short time periods where the radar listens for reflections.

11. The mobile vehicle of claim 7 wherein the interference measuring system estimates the power level at different times and in different subbands.

12. The mobile vehicle of claim 6 wherein the radar system uses FMCW signals.

13. The mobile vehicle of claim 6 wherein the radar system uses PMCW signals.

14. The mobile vehicle of claim 7 wherein the radar system uses FMCW signals.

15. The mobile vehicle of claim 7 wherein the radar system uses PMCW signals.

16. A warehouse system consisting of one or more mobile vehicles wherein the mobile vehicles comprise
one of more radars, and
a communication subsystem;
a central controller wherein the central controller has a subsystem that communicates with and controls the mobile vehicles operation including the time-frequency resource used by the radars.

17. The warehouse system of claim 16, wherein the mobile vehicle has an interference measuring subsystem that measures the interference level in different frequency bands at different times, and wherein the interference measuring subsystem is configured to estimate the power level at different times and in different subbands.

18. The warehouse system of claim 16, wherein the radars transmit with different power levels at different times.

19. The warehouse system of claim 16, wherein not all the radars on a mobile vehicle transmit at the same time, wherein during a transmission time the radar transmits a plurality of short pulses followed by short time periods where the radar listens for reflections.

20. A method for controlling mobile vehicles comprising:
transmitting, with a transmitter on a mobile vehicle, radar signals; and
processing, with a receiver, received signals to determine objects in the environment;
wherein the mobile vehicle controls the selection of a frequency subband and a time of transmission of the radar signals.
